(19) United States
(12) Patent Application Publication
(10) Pub. No.: US 2022/0207475 A1
(43) Pub. Date: Jun. 30, 2022

(54) DATA MANAGEMENT METHOD FOR VARIOUS PRODUCTS AND ELECTRONIC DEVICE USING THE SAME

(71) Applicant: Coupang Corp., Seoul (KR)

(72) Inventors: Ki Woong Jang, Seoul (KR); Deqian Li, Seoul (KR); Cui Jie, Seoul (KR); Yong Geon Kim, Seoul (KR); Nam Woong Cho, Seoul (KR); Tae Hoon Kim, Seoul (KR); Pil Woo Kim, Seoul (KR); Ming Zhang, Seoul (KR); Qingqing Bai, Seoul (KR); Sang Ryul Kim, Seoul (KR); Jeong Min Yun, Seoul (KR); Hae Yeon Lee, Seoul (KR); Prakash Kadel, Seoul (KR); Ku Kang, Seoul (KR); Chang Hyun Park, Seoul (KR); Hyun Bo Kang, Seoul (KR); Da Young Lee, Seoul (KR)

(21) Appl. No.: 17/196,708

(22) Filed: Mar. 9, 2021

(30) Foreign Application Priority Data
Dec. 29, 2020 (KR) 10-2020-0186398

(51) Int. Cl. G06Q 10/08; G06Q 40/08

(52) U.S. Cl. CPC G06Q 10/0833; G06Q 40/08

(57) ABSTRACT

According to various example embodiments, a data management method of an electronic device includes obtaining selection information on or regarding a first product, obtaining selection information on a second product corresponding to the first product based on the selection information on the first product, identifying purchase information about the first product and the second product, transmitting the purchase information about the first product to a first server related to delivery of the first product and transmitting the purchase information about the second product to a second server, and transmitting activation-related information of the second product to the second server in response to delivery status information of the first product, wherein the first product includes a physical product requiring delivery, and the second product includes an insurance product for the first product.

### BACKGROUND

### Technical Field

Various example embodiments of the present disclosure relate to a data management method for various products and an electronic device using the same.

### Description of the Related Art

Managing data on a plurality of products sold by a plurality of sellers may require complex operations. In particular, data management may not be easy when it is not limited to data on products requiring physical delivery but products that do not require physical delivery are sold together.

With the development of electronic devices represented by smartphones, consumers can easily purchase downloadable products and insurance products. Increasingly, products that require physical delivery are purchased together with products that do not require physical delivery. In particular, since the sales of insurance products are increasing, efficient data management may be required.

### SUMMARY

### Technical Goals

In accordance with the management of various products and the operation of the system, insurance products, which are intangible products for compensating damage to physical products, as well as products that require delivery, represented as physical products, are diversifying.

Mobile phones and insurance products may be representative cases that are sold together as tangible products and intangible products. Recently, large-sized electronic products are being actively sold online, and insurance products coupled with large-sized electronic products may also be sold.

In the case of selling tangible products and intangible products together as described above, it is necessary to efficiently manage the time when the intangible products are activated upon completion of the transaction and whether the intangible products are activated according to the completion of the purchase of the tangible products.

### Technical Solutions

According to an aspect of the present disclosure, there is provided a method of managing data by an electronic device, the method including obtaining selection information on or regarding a first product, obtaining selection information on a second product corresponding to the first product based on the selection information on the first product, identifying purchase information about the first product and the second product, transmitting the purchase information about the first product to a first server related to delivery of the first product and transmitting the purchase information about the second product to a second server, and transmitting activation-related information of the second product to the second server in response to delivery status information of the first product, wherein the first product includes a physical product requiring delivery, and the second product includes an insurance product for the first product.

According to another aspect of the present disclosure, there is also provided an electronic device using a method of managing data on various products, the electronic device including a database, a transceiver, and a processor, wherein the processor is configured to obtain selection information on a first product, obtain selection information on a second product corresponding to the first product based on the selection information on the first product, identify purchase information about the first product and the second product, transmit the purchase information about the first product to a first server related to delivery of the first product and transmit the purchase information about the second product to a second server, and transmit activation-related information of the second product to the second server in response to delivery status information of the first product, the first product includes a physical product requiring delivery, and the second product includes an insurance product for the first product.

### Effects

A data management method according to various example embodiments allows sales of tangible products and intangible products related to the tangible products together and efficient management thereof by changing the activation status information of the intangible products based on the delivery status information of the tangible products when selling the tangible products and the intangible products corresponding to the tangible products together.

An electronic device according to various example embodiments allows efficient management of data on various products while providing the activation status information of intangible products corresponding to tangible products according to the delivery status of the tangible products.

### BRIEF DESCRIPTION OF THE DRAWINGS

FIG. 1 is a block diagram illustrating an electronic device in a network environment according to various example embodiments.

FIG. 2 is a flowchart illustrating a data management method according to various example embodiments.

FIG. 3 is a flowchart illustrating a method of managing data of a physical product and an insurance product together according to various example embodiments.

FIG. 4 is a flowchart illustrating data transmission between an electronic device using a data management method and an external device according to various example embodiments.

FIG. 5 is a diagram illustrating an example of a data management method of an electronic device according to various example embodiments.

FIG. 6 is a diagram illustrating an example of a method of managing data of a physical product and a digital product together according to various example embodiments.

### DETAILED DESCRIPTION

The terms used in the example embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “includes” a certain component, it means that other components may be further included, and it does not preclude other components, unless otherwise stated. In addition, terms such as “ . . . unit”, “ . . . module” described in the specification mean a unit for performing at least one function or operation, which may be implemented as hardware or software, or as a combination of hardware and software.

The expression “at least one of A, B, and C” may include the following meanings: A alone; B alone; C alone; both A and B together; both A and C together; both B and C together; and all three of A, B, and C together.

In the present disclosure, a “terminal” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, example embodiments of the present disclosure will be described in detail with reference to the drawings so that those skilled in the art can easily carry out the present disclosure. The present disclosure may be embodied in many different forms and is not limited to the example embodiments described herein.

Hereinafter, example embodiments of the present disclosure will be described with reference to the drawings.

In describing the example embodiments, descriptions of technical contents that are well known in the art to which the present disclosure belongs and are not directly related to the present specification will be omitted. This is to more clearly communicate without obscure the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

At this point, it will be understood that each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus the computer usable or computer readable memory. It is also possible for the instructions stored in to produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

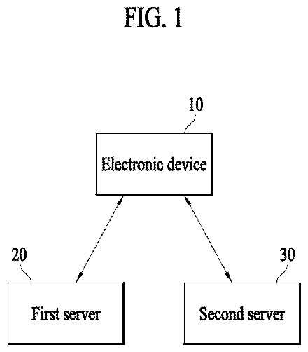

FIG. 1 is a block diagram illustrating an electronic device in a network environment according to various example embodiments.

Referring to FIG. 1, in a network environment, an electronic device 10 may communicate with a first server 20 or a second server 30 through a network (e.g., a wireless communication network or a remote wireless communication network).

The electronic device 10 is a device in which a system for processing various operations is built, and may perform operation processing through a language including, for example, a developer's processing instruction.

The electronic device 10 may include a plurality of computer systems implemented as network servers or computer software and may provide various pieces of information according to web pages or control tools. For example, the electronic device 10 may refer to a computer system and computer software that can communicate with a network server through a network and is connected to an external device to receive a request to perform a task, perform the task, and provide a result of the task.

The electronic device 10 may be a device that manages data on various products, and the various products may be products with physical forms. For example, the electronic device 10 may manage data for selling products with physical forms including mobile phones, TVs, air conditioners, washing machines, or computers. Various products may include products that can be physically delivered to a purchaser.

The electronic device 10 may manage data on various products, and the various products may be products without physical forms or products related to physical products. For example, the electronic device 10 may manage data for selling an insurance product, a downloadable digital product, or a product without a physical form related to a product with a physical form. Various products may include products that cannot be physically delivered.

The electronic device 10 may manage data on various products, and the various products may be products with physical forms and products without physical forms related to the products with physical forms. For example, the electronic device 10 may manage data for selling a mobile phone, which is a product with a physical form, and an insurance product related to the mobile phone, which is a product without a physical form. Various products may include products that can be physically delivered to a purchaser and products that cannot be physically delivered.

Various products corresponding to data managed by the electronic device 10 may include products with physical forms and products without physical forms. For example, products with physical forms may include products requiring physical delivery, and products without physical forms may include products that do not require physical delivery. In this specification, a product with a physical form may be referred to as a tangible product or a first product, and a product without a physical form may be referred to as an intangible product or a second product. The second product may include an insurance product, which may be sold together as a product corresponding to the first product. A user who communicates with the electronic device 10 via a network may purchase the second product on the premise of purchasing the first product. For example, the user may purchase only the first product or may purchase both the first product and the second product related to the first product.

The electronic device 10 may include a processor, a database, and a transceiver. The processor may process a series of steps for performing a method of managing data according to various example embodiments of the present disclosure. For example, the processor may control other components of the electronic device 10. The processor may be functionally, operatively, or electrically connected to internal components of the electronic device 10 including the database and the transceiver.

The transceiver may transmit information stored in the database of the electronic device 10 or information processed by the processor to another device or may receive information from another device to the electronic device 10. For example, the transceiver may transmit information to at least one of the first server and the second server. For another example, the transceiver may receive information from at least one of the first server and the second server.

The database is a data structure implemented in a predetermined storage space of the electronic device 10, and functions such as storing, searching, deleting, editing, or adding data may be freely performed. For example, the database may include fields or elements for processing functions such as storing, searching, deleting, editing, or adding data. The database may store data related to the electronic device 10 performing a method of managing data. For example, the database may store instructions or data for an execution operation of the processor.

The first server 20 may communicate with the electronic device 10 via a network. The first server 20 may include a server in charge of delivery of various products for sale through the electronic device 10. For example, the first server 20 may be responsible for delivery of the first product in response to an order for the first product input to the electronic device 10. The first server 20 may transmit identification information on the first product to the electronic device 10 in response to an order for the first product input to the electronic device 10. For example, the first server 20 may transmit the identification information to the electronic device according to the product type of the first product in response to the received sales information about the first product. The product type of the first product for which the first server 20 transmits the identification information of the first product to the electronic device 10 may not correspond to a preset type.

The first server 20 may include a processor, a database, and a transceiver. The first server 20 may include at least one server and may include servers of a distribution center for products (e.g., the first products) to be sold through the electronic device 10, a central control shipment center, or external companies related to the delivery of products brokered and sold using the platform operated by the electronic device 10.

The second server 30 may communicate with the electronic device 10 via a network. The second server 30 may be a server that shares information on the second product among various products for sale through the electronic device 10 with the electronic device 10. For example, the second server 30 may receive information on the second product in response to an order for the second product input to the electronic device 10. The information on the second product may include activation-related information of the second product, for example, when the second product is an insurance product. The activation-related information of the second product may be determined in response to information on the delivery status of the first product sold together with the second product.

The second server 30 may include a processor, a database, and a transceiver. The second server 30 may include at least one server and may include a server that shares information on products (e.g., the second product) for sale through the electronic device 10 with the electronic device 10. The second server 30 includes servers of one or more different insurance companies, and the second products shared between the second server 30 and the electronic device 10 may include one or more different insurance products of one or more different insurance companies.

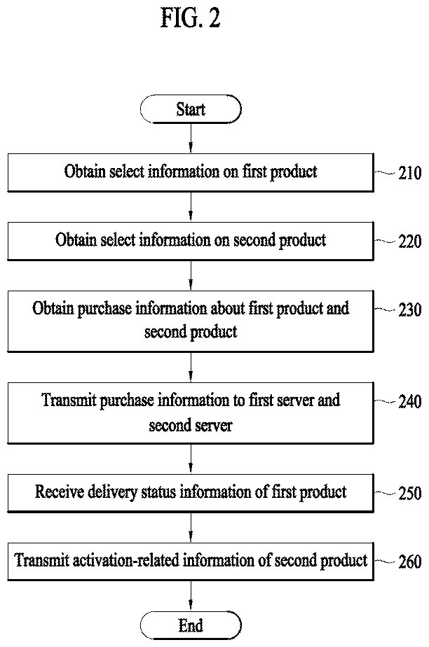

FIG. 2 is a flowchart illustrating a data management method according to various example embodiments.

Referring to FIG. 2, a method of selecting respective product in an electronic device of an example embodiment, transmitting information about it to another server and receiving information from another server is illustrated.

In operation 210, a processor of an electronic device (e.g., the electronic device 10 of FIG. 1) may obtain selection information on or regarding a first product. For example, the electronic device may provide a search result by receiving search information for a name of a product that a user wants to purchase. The electronic device may obtain a selection input for a product from the user and provide an order page corresponding to the selection input. The electronic device may receive the selection input for the first product of the user in the order page. For example, the first product may include a physical product that can be physically delivered to a purchaser. The selection information on the first product for which the user can perform selection input may include information on a product type and an attribute corresponding to the product type. For example, the product type may include a first mobile phone, and an attribute corresponding to the product type may include a color, a capacity of a storage medium, or a telecommunication company.

In operation 220, the processor of the electronic device may obtain selection information on the second product. In an example embodiment, the electronic device may provide information on the second product together with the information on the first product or in response to the selection information on the first product and obtain the selection information on the second product from the user in response to the provided information. The processor of the electronic device may obtain the selection information on the second product corresponding to the first product based on the selection information on the first product. When the selection information on the first product is the first mobile phone, for example, the selection information on the second product may include information on a user's selection input selecting one of a plurality of insurance products corresponding to the first mobile phone.

In operation 230, the processor of the electronic device may identify purchase information about the first product and the second product. The processor of the electronic device may identify the purchase information about the first product and the second product finally purchased by the user in the order step based on the selection information on the first product and the second product. For example, the user may purchase only the first product or purchase both the first product and the second product. Hereinafter, description will be made based on purchasing both the first product and the second product.

In operation 240, the processor of the electronic device may transmit the purchase information to the first server (e.g., the first server 20 of FIG. 1) and the second server (e.g., the second server 30 of FIG. 1). For example, the processor of the electronic device may transmit the purchase information on the first product to the first server related to delivery of the first product. The processor of the electronic device may transmit the purchase information on the second product to the second server. Meanwhile, depending on the kind of the first product, the first server may be a server operated by the same operator as the electronic device or a server operated by a separate operator. In addition, the first server operated by the same operator as the electronic device may transmit information related to purchase to a server operated by a separate operator. The first server may perform a process related to delivery of the first product based on the information received from the electronic device, and then obtain information about the delivery to provide the electronic device therewith, or directly provide the user and at least one of the second servers with this information.

In operation 250, the processor of the electronic device may receive delivery status information of the first product. For example, the processor of the electronic device may receive the delivery status information of the first product from the first server that stores and manages the delivery status information of the first product. The delivery status information of the first product may include information of delivery start, delivery completion, return completion due to refund, or delivery start and delivery completion due to exchange.

In operation 260, the processor of the electronic device may transmit activation-related information of the second product. For example, the processor of the electronic device may transmit the activation-related information of the second product to the second server in response to the delivery status information of the first product. The second product may include an insurance product and may include a product that cannot be physically delivered. The second product may be purchased together when there is a purchase of the first product. The processor of the electronic device identifies the user's purchase information about the first product and the second product and, if there is purchase information about the second product, it may transmit the activation-related information of the second product to the second server that shares the information of the identified second product. When the second product is an insurance product, for example, the activation-related information of the second product may include information on the activation time of the insurance product.

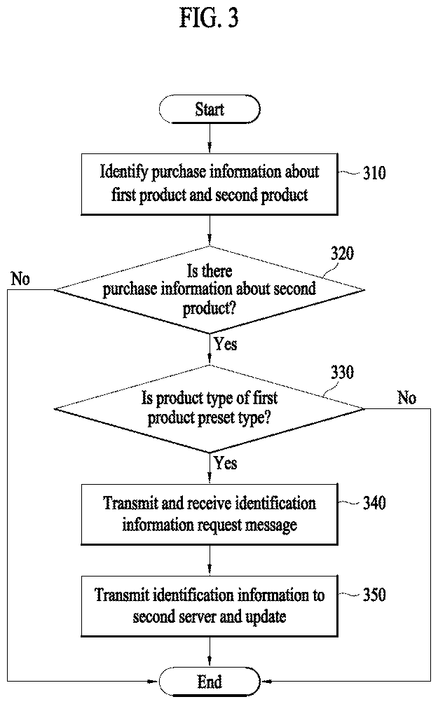

FIG. 3 is a flowchart illustrating a method of managing data of a physical product and an insurance product together according to various example embodiments.

Referring to FIG. 3, an information processing method for activation of a second product is shown.

In operation 310, a processor of an electronic device (e.g., the electronic device 10 of FIG. 1) may identify purchase information about a first product and a second product. The processor of the electronic device may identify the purchase information about the first product and the second product finally purchased by the user in the order step based on the selection information on the first product and the second product. For example, the user may purchase only the first product or purchase both the first product and the second product.

In operation 320, the processor of the electronic device may determine whether there is purchase information about the second product. For example, the processor of the electronic device may determine whether there is purchase information about the second product based on the purchase information identified in operation 310. As for the purchase information about the first product and the second product, for example, purchase information about only the first product may exist or purchase information about both the first product and the second product may exist. If it is determined that there is no purchase information about the second product in operation 320, the processor of the electronic device may not transmit the activation-related information of the second product to the second server (e.g., the second server 30 of FIG. 1). If there is no purchase information about the second product, the activation-related information of the second product that can be generated in response to the delivery status information of the first product may not exist.

The electronic device may update activation-related information of the second product based on the delivery status information of the first product. The delivery status information of the first product may be received from the first server (e.g., the first server 20 of FIG. 1). The delivery status information of the first product may be received through the first server as information of delivery start. For example, when the delivery status information of the first product is information of delivery start, the activation information of the second product may be information of inactive state. The second product may be an insurance product for the first product, and the active state of the insurance product may indicate a state in which the insurance is being effective. For another example, the second product may be an insurance product for the first product, and the inactive state of the insurance product may indicate a state in which the insurance is not being effective. When the delivery status information of the first product is information of delivery completion, the activation information of the second product may be updated to the information of active state. For example, when the delivery status information of the first product corresponds to delivery completion, the processor of the electronic device may provide the user and at least one of the second servers with the activation-related information of the second product. The activation-related information of the second product may include information of active state, information of inactive state, or information on an activation time.

In operation 330, the processor of the electronic device may determine whether the type of the first product is a preset type. When it is determined that the type of the first product is not a preset type in operation 330, the processor of the electronic device may receive identification information of the first product while obtaining information of delivery start among the delivery status information of the first product, or the identification information may be received by including in purchase information about the first product. For example, when the first product is a mobile phone, the electronic device may receive identification information of the mobile phone while obtaining information about delivery start of the mobile phone or may receive the identification information included in purchase information about the mobile phone. In operation 320, when there is purchase information on or regarding the second product, the activation-related information on the second product may be provided in response to the delivery status of the first product even if the type of the first product is a preset type or not a preset type. The preset type may be a type in which the identification information cannot be transmitted together when the first server transmits the information of delivery start among the delivery status information of the first product to the electronic device. When the first product is a mobile phone, for example, it may be determined that the type of the first product is not a preset type. For another example, when the first product is released for delivery start of the first product and the identification information of the first product cannot be identified, the type of the first product may be determined to be a preset type. Determining whether the type of the first product is a preset type in operation 330 may include determining whether information of delivery start and identification information of the first product are received together from the first server. If it is determined in operation 330 that the type of the first product is a preset type, the processor of the electronic device may proceed to operation 340.

The processor of the electronic device may transmit and receive an identification information request message of the first product to the user in operation 340. For example, when it is determined that a type of the first product is a preset product type, the processor of the electronic device may transmit a message requesting the identification information of the first product delivered to the user. The transmission time of the identification information request message of the first product may include consecutive time points including the time when the information of delivery start among the delivery status information of the first product is received and the time when the information of delivery completion among the delivery status information of the first product is received. The user may transmit a response message including the identification information of the first product to the electronic device in response to the request message. The processor of the electronic device may transmit the identification information of the first product to the second server based on the response message including the identification information of the first product.

The processor of the electronic device may transmit the identification information to the second server in operation 350. The second product may be updated with information of active state in response to the information of delivery completion among delivery state information of the first product. When the type of the first product is a preset type, the second product may be changed from an inactive state to an active state in response to the information of delivery completion. The identification information of the first product is like the unique ID, and the second product may be activated or deactivated in a one-to-one correspondence with the identification information of the first product. Even when the delivery of the first product is completed and the activation of the second product is in progress, the identification information of the first product may not be transmitted to the second server. Even before the second server receives the identification information of the first product, the activation of the second product corresponding to the first product is in progress, and the identification information of the first product may be later updated to the second server to identify the product for which the insurance is activated. Upon delivery completion of the first product, the user may actually use the first product, and the second product, which is an insurance product against damage to the first product, needs to be activated from the time when the first product is actually used. Operations 330 to 350 may correspond to an example of an information processing method in which the activation time of the second product may be set corresponding to the actual use time of the first product. Operations 340 and 350 may be omitted if the type of the first product is not a preset type. Performing operations 330 to 350 may be for managing information by updating the identification information of the first product after activation of the second product for the first product when the type of the first product is a preset type.

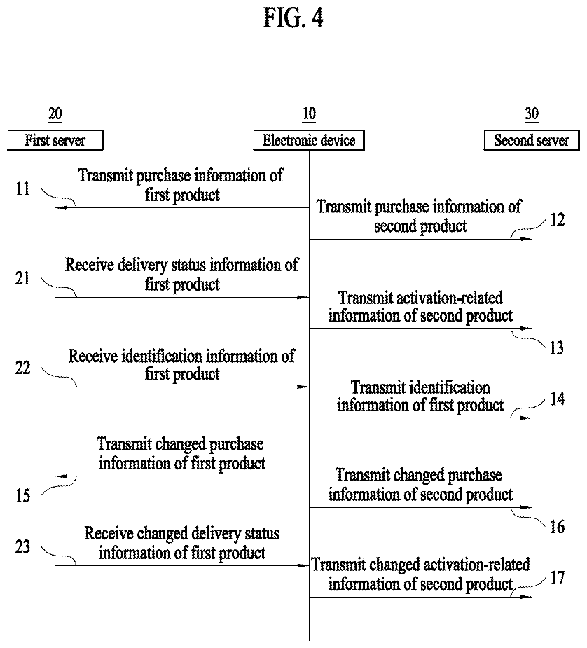

FIG. 4 is a flowchart illustrating data transmission between an electronic device using a data management method and an external device according to various example embodiments.

The electronic device 10 may transmit purchase information about the first product to the first server 20 in operation 11. The electronic device 10 may transmit purchase information about the second product to the second server 30 in operation 12.

The electronic device 10 may receive delivery status information of the first product from the first server 20 in operation 21. The delivery status information of the first product may include information of delivery start, delivery completion, return completion due to refund, or delivery start and delivery completion due to exchange. The electronic device 10 may transmit activation-related information of the second product to the second server 30 in operation 13. For example, upon receiving information of delivery completion among delivery status information of the first product in operation 21, the electronic device 10 may transmit the activation-related information of the second product to the second server 30. The information of delivery completion of the first product may correspond to information of active state of the second product. For example, a time point at which the first product is delivered to the user may correspond to a time point at which the active state of the second product is started.

The electronic device 10 may receive identification information of the first product from the first server 20 in operation 22. As an example, if the electronic device 10 determines that the product type of the first product among the identified purchase information of the first product is a preset type, the identification information of the first product may be received from the first server 20 in operation 22. As another example, if the electronic device 10 determines that the product type of the first product among the identified purchase information of the first product is not a preset type, operation 22 may be omitted, and identification information of the first product may be received from the user through a response message. On the other hand, operation 22 may be received in response to the release for delivery of the first product and performed before operation 21. The identification information of the first product may include information for specifying the first product, and, for example, it may include a serial number assigned to the corresponding product. By providing such information to the second server, insurance information for the product may be generated. Insurance companies can activate their insurance products based on the information they receive. In addition, when delivery is completed before the identification information of the first product is received, the insurance is first activated arbitrarily and then the insurance information is completed upon receiving the product information.

The electronic device 10 may transmit the identification information of the first product to the second server 30 in operation 14. As example, if it is determined that the product type of the first product among the identified purchase information of the first product is a preset type, the electronic device 10 may transmit the identification information of the first product to the second server. As another example, if it is determined that the product type of the first product among the identified purchase information of the first product is not a preset type, operation 22 may be omitted, and the electronic device 10 may transmit the identification information of the first product received from the user through a response message to the second server.

After the delivery of the first product is completed, the electronic device 10 may obtain a selection input of the user for purchase confirmation, exchange, or refund on the first product. The electronic device 10 may transmit the purchase information of the first product changed based on the user's selection input in operation 15 to the first server 20. For example, the selection input for proceeding to operation 15 may include a selection input for exchange or refund. For another example, when a selection input for purchase confirmation is obtained as a selection input, the electronic device 10 may omit operations 15, 16, 17, and 23.

When a selection input of the user for exchange or refund on the first product is obtained in operation 15, the electronic device 10 may transmit the changed purchase information of the first product to the first server 20. As an example, a selection input for exchange of the first product is obtained, and then the electronic device 10 may proceed to operation 15. The purchase information of the first product changed in response to the selection input for exchange may include information in which the first product has the same product type with a different attribute, or the first product has a different product type with the same or different attribute. The electronic device 10 may check whether information on the product type has been changed in response to the changed purchase information of the first product. As another example, if a selection input for refund on the first product is obtained, and the electronic device 10 may proceed to operation 15. The purchase information of the first product changed in response to the selection input for refund may include information on the return progress without the purchase of the first product.

The electronic device 10 may transmit the changed purchase information about the second product to the second server 30. The changed purchase information about the second product may be based on the selection input of the user for the changed purchase information of the first product in operation 15. As example, a user's input for exchange of the first product and an input for refund on the second product purchased together may be obtained. As another example, when the user inputs for exchange of the first product, the product type becomes different, and the second product corresponding to the changed first product may be changed. The user may input for exchange of the first insurance product purchased together with the first mobile phone for the second insurance product and the second mobile phone.

The electronic device 10 may receive the changed delivery status information of the first product from the first server 20 in operation 23. For example, the delivery status change information of the first product, which may be transmitted in operation 17, may include information of return completion due to a refund or delivery start and delivery completion due to an exchange.

The electronic device 10 may transmit activation-related information of the second product to the second server 30 in operation 17. The activation-related information of the second product transmitted in operations 13 and 17 may be the same or different. As an example, when a selection input for refund on the first product is obtained, in response to receiving information of return completion due to the refund among the delivery status change information of the first product in operation 23, the electronic device 10 may transmit information on start of the inactive state or deactivation and refund on the second product to the second server 30. When the selection input for refund on the first product is obtained, the electronic device 10 may also obtain the selection input for refund on the second product at the same time and proceeds to operation 17 to transmit information on start of the inactive state of the second product or deactivation and refund on the second product to the second server 30. As another example, when the selection input for exchange of the first product is obtained, in response to receiving information of delivery completion due to the exchange among the delivery status change information of the first product, the electronic device 10 may transmit information on a change in the active state start point of the second product or refund on the second product to the second server 30.

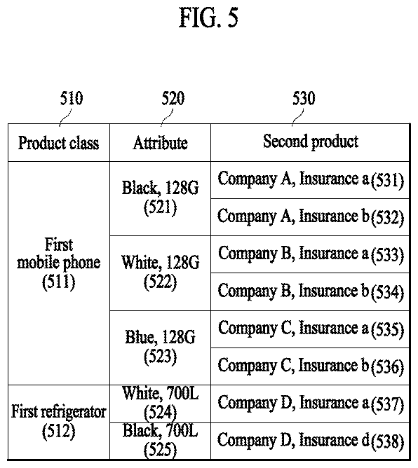

FIG. 5 is a diagram illustrating an example of a data management method of an electronic device according to various example embodiments.

An electronic device (e.g., the electronic device 10 of FIG. 1) may manage data on the first product and the second product as a table in the form shown in FIG. 5. For example, a product class 510 may include various products including a first mobile phone 511 and a first refrigerator 512. Referring to FIG. 5, a product that may be included in the product class 510 may be a class of the first products, which may include a class of products that can be physically delivered to a purchaser. The product class 510 may include information on or regarding a type of a product among selection information on the first product. The product class 510 may be a concept encompassing the classes of mobile phones, TVs, air conditioners, washing machines, or computers that may be included as the first products.

The electronic device may manage information on an attribute 520 corresponding to the product class or product type of the first product. For example, the attribute 520 may include information that may be selected based on information on selecting a product class or a product type of the first product. In the example of FIG. 5, when a user selects the product class 510 of the first product as the first mobile phone 511, the electronic device may provide information on subordinate attributes 521 to 523 corresponding to the first mobile phone 511. The electronic device may obtain a selection input of the user regarding the first product. For example, the selection input of the user for the first product may include the first mobile phone 511 and one of the attributes (one of the subordinate attributes 521 to 523) corresponding thereto. In the example of FIG. 5, the selection information on the first product that the user can select to input may be selecting at least one of the subordinate attributes 521 to 523 when the first mobile phone 511 is selected or selecting at least one of attributes 524 to 525 when the first refrigerator 512 is selected.

The electronic device may manage selection information on a second product 530 corresponding to the first product based on the selection information on the first product. For example, the second product 530 may include selection information 531 to 538. In the example of FIG. 5, the second product 530 may be set to be provided based on selection information on the first product. For example, when insurance products related to mobile phones are provided by companies A, C, and D, based on selection information on the first product that the user selected attribute 522 of the first mobile phone 511, the electronic device may be set to display the selection information 531, 532, 535 to 538 on the second product so that the user can select to input. The second product 530 may have different classes and numbers of products that the user can select according to the first product.

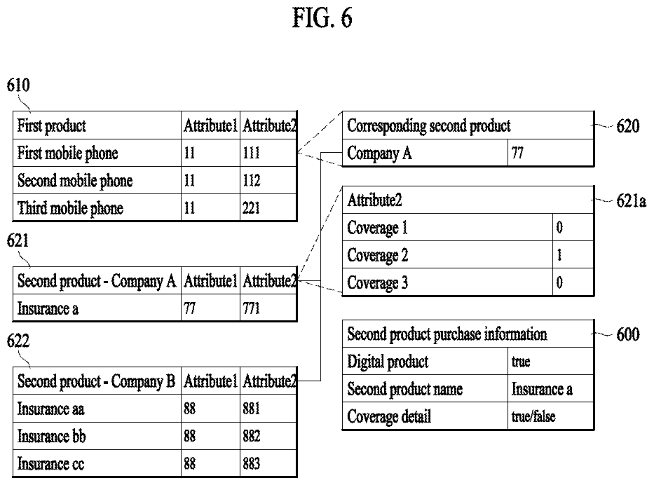

FIG. 6 is a diagram illustrating an example of a method of managing data of a physical product and a digital product together according to various example embodiments.

A physical product may include a first product, which is a product in which the physical product can be delivered to a purchaser. A digital product may include a second product, which is a product that cannot be physically delivered to a purchaser.

An electronic device (e.g., the electronic device 10 of FIG. 1) may manage information on the first product and the second product. The example illustrated in FIG. 6 may be a data management method of an electronic device that simultaneously manages information according to selection information of a user on the first product and the second product.

Information 610 on the first product may be, as illustrated in FIG. 6, composed of a product class or a product type, attribute 1, and attribute 2 of the first product. The user may select at least one of a first mobile phone, a second mobile phone, or a third mobile phone as the product class or product type of the first product. In the attribute 1, the electronic device may identify a number or ID of the attribute 1 corresponding to the product class or product type of the first product. In the attribute 2, the electronic device may identify a number or ID of the attribute 2 corresponding to the product class or product type of the first product. Referring to FIG. 6, the electronic device may identify the class of the second product corresponding to the first product through the attribute 2 of the information 610 on the first product. For example, the electronic device identifies selection information on the first mobile phone as the product class or product type of the first product, identifies the number or ID of attribute 2 based on the identified selection information, and may provide the user with information on the second product, which is an insurance product linked to the first mobile phone. The user may input a selection for selecting at least one of the provided information on the second product.

Information 620 on the second product corresponding to the first product may include information on the insurance company for the second product and information on the contents of the coverage for the second product. For example, as illustrated in FIG. 6, the information 620 on the second product may include information on the insurance company A for the second product corresponding to the selection information on the first mobile phone. The electronic device can manage data with company A as a number or ID of 77, and if company B also has a second product corresponding to the first mobile phone, a number or ID different from company A's 77 can be assigned to be managed.

Information on or regarding the insurance company for the second product may be managed as shown in tables 621 and 622. As an example, the second product of company A is insurance a, an attribute 1 is managed by a number 77 managed in the table 620, and an attribute 2 may also be managed by a number (e.g., 771) or ID. As another example, the second product of company B may be composed of insurance aa, insurance bb, and insurance cc, and the attribute 1 is managed by a number 88, and the attribute 2 may also be managed by numbers (e.g., 881 to 883) or IDs. As shown in FIG. 6, the second product corresponding to the first mobile phone is limited to the insurance product of company A, and the insurance product of company B may not be linked. Attribute 1 of the insurance company information for the second product may correspond to a unique number or ID for the insurance company.

The information 620 on the second product may include information 621a of the second product attribute 2 of company A. The second product attribute 2 of company A may include information on matters related to the contents of the coverage. The insurance coverage included in the insurance a, which is the second product of the company A, may be at least one of the coverages 1 to 3. Referring to FIG. 6, in the information 621a, the insurance a, which is the second product of the company A, is may be managed as information in which the content of coverage 1 and the content of coverage 3 are written as 0 because those are not included and only the included content of coverage 2 is written as 1.

The electronic device may manage purchase information of a user on the second product as data 600 shown in FIG. 6. For example, the electronic device may bundle and manage data about a first mobile phone, which is a first product purchased by a user, and an insurance a, which is a second product corresponding to the first product. Referring to FIG. 6, second product purchase information purchased by the user may be written and managed as “true” if it corresponds to a digital product and “false” if it does not. The name of the second product can be entered and managed as insurance a. The details of the coverage may include information 621a on the coverage of the purchased second product, and it may also include information on whether it is possible to separately purchase the insurance product corresponding to the second product only, whether it is possible to exchange the second product only, whether a refund of the second product is possible, and the like.

According to various example embodiments, a data management method of an electronic device may include an operation of obtaining selection information on a first product, an operation of obtaining selection information on a second product corresponding to the first product based on the selection information on the first product, an operation of identifying purchase information about the first product and the second product, an operation of transmitting the purchase information about the first product to a first server related to delivery of the first product and transmitting the purchase information about the second product to a second server, and an operation of transmitting activation-related information of the second product to the second server in response to delivery status information of the first product. The first product may include a physical product requiring delivery. The second product may include an insurance product for the first product.

The data management method may further include an operation of obtaining the delivery status information of the first product and an operation of providing the activation-related information of the second product based on the delivery status information. The selection information on the first product may include information on a product type and an attribute corresponding to the product type. An activation time of the insurance product may be determined in response to the activation-related information of the second product.

The data management method may further include an operation of receiving identification information of the first product from the first server according to the delivery status information of the first product and an operation of transmitting the identification information of the first product to the second server. The delivery status information of the first product may be delivery start information.

The data management method may further include an operation of transmitting an identification information request message of the first product to the user according to the product type of the first product. The product type of the first product may correspond to a preset product type.

The data management method may further include an operation of receiving a response message including the identification information of the first product in response to the request message and an operation of transmitting the identification information of the first product to the second server based on the response message.

In the data management method, the operation of providing the activation-related information of the second product may include an operation of providing the activation-related information of the second product if the delivery status information corresponds to information of delivery completion.

In the data management method, the operation of providing the activation-related information of the second product may include an operation of transmitting information on the activation time of the insurance product to the second server in response to the information of delivery completion. The information on the activation time of the insurance product may be determined based on information of delivery completion of the first product.

The data management method may further include an operation of identifying changed purchase information about the first product and the second product, an operation of transmitting the changed purchase information of the first product to the first server and transmitting the changed purchase information of the second product to the second server, and an operation of providing changed activation-related information of the second product to the second server upon receiving changed delivery status information of the first product.

The data management method may further include an operation of receiving changed identification information of the first product from the first server and an operation of transmitting the changed identification information of the first product to the second server. The changed purchase information about the first product may correspond to an exchange input of the user.

The data management method may further include an operation of transmitting a changed identification information request message of the first product to the user based on the changed purchase information of the first product, an operation of receiving a response message including the changed identification information of the first product in response to the request message, and an operation of transmitting the changed identification information of the first product to the second server based on the response message. The changed purchase information about the first product may correspond to an exchange input of the user.

An electronic device using a data management method for various products according to various example embodiments may include a database, a transceiver, and a processor. The processor may obtain selection information on a first product, obtain selection information on a second product corresponding to the first product based on the selection information on the first product, identify purchase information about the first product and the second product, transmit the purchase information about the first product to a first server related to delivery of the first product, transmit the purchase information about the second product to a second server, and transmit activation-related information of the second product to the second server in response to delivery status information of the first product. The first product may include a physical product requiring delivery. The second product may include an insurance product for the first product.

The processor of the electronic device may obtain the delivery status information of the first product and provide the activation-related information of the second product based on the delivery status information. The selection information on the first product may include information on a product type and an attribute corresponding to the product type. An activation time of the insurance product may be determined in response to the activation-related information of the second product.

The processor of the electronic device may receive identification information of the first product from the first server according to the delivery status information of the first product and transmit the identification information of the first product to the second server. The delivery status information of the first product may include delivery start information.

The processor of the electronic device may transmit an identification information request message of the first product to a user according to the product type of the first product. The product type of the first product may correspond to a preset product type.

The processor of the electronic device may receive a response message including the identification information of the first product in response to the request message and transmit the identification information of the first product to the second server based on the response message.

The processor of the electronic device may provide the activation-related information of the second product if the delivery status information corresponds to information of delivery completion.

The processor of the electronic device may transmit information on the activation time of the insurance product to the second server in response to the information of delivery completion. The information on the activation time of the insurance product may be determined based on information of delivery completion of the first product.

The processor of the electronic device may identify changed purchase information about the first product and the second product, transmit the changed purchase information of the first product to the first server, transmit the changed purchase information of the second product to the second server, and provide changed activation-related information of the second product to the second server upon receiving changed delivery status information of the first product.

The processor of the electronic device may receive changed identification information of the first product from the first server and transmit the changed identification information of the first product to the second server. The changed purchase information about the first product may correspond to an exchange input of the user.

The processor of the electronic device may transmit a changed identification information request message of the first product to the user based on the changed purchase information of the first product, receive a response message including the changed identification information of the first product in response to the request message, and transmit the changed identification information of the first product to the second server based on the response message. The changed purchase information about the first product may correspond to an exchange input of the user.

The present specification and drawings have been described with respect to the example embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

The electronic apparatus or terminal in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

1. A method operable by an electronic apparatus to manage data, the method comprising:
controlling, by a processor of the electronic apparatus, a transceiver of the electronic apparatus to communicate with a first server and a user device;
receiving, from the user device via the transceiver, first selection information regarding a first product, wherein the first product comprises a physical product requiring delivery;
receiving, from the user device via the transceiver, second selection information regarding a second product corresponding to the first product based on the first selection information regarding the first product, wherein the second product comprises an insurance product for the first product;
identifying, by the processor, purchase information regarding the first product and the second product based on the first selection information and the second selection information;
generating, by the processor, a first request for identification information and delivery information of the first product from the first server;
based on a response from the first server to the first request not including the identification information together with the delivery information of the first product, determining, by the processor, that the first product is of a predetermined type for which identification information is not available at the time of the response to the first request;
in response to determining that the first product is of the predetermined type, generating, by the processor, a second request for the identification information of the first product from the user device;
receiving, from the user device via the transceiver, a response to the second request for the identification information of the first product; and
in response to the identification information of the first product from the user device matching the identification information from the first server, causing the processor to generate activation information for the second product.

2. The method of claim 1, further comprising:
obtaining delivery status information of the first product; and
providing the activation information of the second product based on the delivery status information,
wherein the selection information regarding the first product includes information regarding a product type and an attribute corresponding to the product type, and
an activation time of the second product is determined in response to the activation information of the second product.

3. The method of claim 2, wherein:
the delivery status information of the first product is delivery start information.

4. (canceled)

5. The method of claim 1, further comprising:
transmitting the identification information of the first product to a second server based on the response from the user device, wherein the second server is associated with the second device.

6. The method of claim 2, wherein the activation-related information of the second product is provided in response to determining that the delivery status information corresponds to information of delivery completion of the first product.

7. The method of claim 6, wherein an activation time of the insurance product is determined based on the information of delivery completion of the first product.

8. The method of claim 1, further comprising:
identifying changed purchase information about the first product and the second product;
transmitting the changed purchase information of the first product to the first server and transmitting the changed purchase information of the second product to a second server, the second server different from the first server; and
providing changed activation information of the second product to the second server in response to receiving the changed delivery status information of the first product from the first server.

9. The method of claim 8, further comprising:
receiving changed identification information of the first product from the first server; and
transmitting the changed identification information of the first product to the second server,
wherein the changed purchase information about the first product corresponds to an exchange input of the user.

10. The method of claim 8, further comprising:
generating a request message requesting for the changed identification information of the first product from the user device based on the changed purchase information of the first product;
receiving a response to the request message including the changed identification information of the first product; and
transmitting the changed identification information of the first product to the second server,
wherein the changed purchase information about the first product corresponds to an exchange input of the user.

11. An electronic device for managing data on various products, the electronic device comprising:
a database;
a transceiver; and
a processor,
wherein the processor is configured to:
control a transceiver to communicate with a first server and a user device;
receive, from the user device, first selection information regarding a first product, wherein the first product comprises a physical product requiring delivery;
receive, from the user device, second selection information regarding a second product corresponding to the first product based on the first selection information regarding the first product, wherein the second product comprises an insurance product for the first product;
identify purchase information regarding the first product and the second product based on the first selection information and the second selection information;
generate a first request for identification information and delivery information of the first product from the first server;
based on a response from the first server to the first request not including the identification information together with the delivery information of the first product, determine that the first product is of a predetermined type for which identification information is not available at the time of the response to the first request;
in response to determining that the first product is of the predetermined type, generate a second request for the identification information of the first product from the user device;
receive, from the user device via the transceiver, a response to the second request for the identification information of the first product; and
in response to the identification information of the first product from the user device matching the identification information from the first server, generate activation information for the second product.

12. The electronic device of claim 11, wherein the processor is further configured to:
obtain delivery status information of the first product; and
provide the activation information of the second product based on the delivery status information,
the selection information regarding the first product includes information regarding a product type and an attribute corresponding to the product type, and
an activation time of the second product is determined in response to the activation information of the second product.

13. The electronic device of claim 12, wherein the delivery status information of the first product is delivery start information.

14. (canceled)

15. The electronic device of claim 11, wherein the processor is further configured to:
transmit the identification information of the first product to a second server based on the response from the user device, wherein the second server is associated with the second device.

16. The electronic device of claim 12, wherein the activation-related information of the second product is provided in response to a determination that the delivery status information corresponds to information of delivery completion of the first product.

17. The electronic device of claim 16, wherein an activation time of the insurance product is determined based on the information of delivery completion of the first product.

18. The electronic device of claim 11, wherein the processor is further configured to:
identify changed purchase information about the first product and the second product;
transmit the changed purchase information of the first product to the first server and transmitting the changed purchase information of the second product to a second server, the second server different from the first server; and
provide changed activation information of the second product to the second server in response to receiving the changed delivery status information of the first product from the first server.

19. The electronic device of claim 18, wherein the processor is further configured to:
receive changed identification information of the first product from the first server; and
transmit the changed identification information of the first product to the second server,
wherein the changed purchase information about the first product corresponds to an exchange input of the user.

20. The electronic device of claim 18, wherein the processor is further configured to:
generate a request message requesting for the changed identification information of the first product from the user device based on the changed purchase information of the first product;
receive a response to the request message including the changed identification information of the first product; and
transmit the changed identification information of the first product to the second server,
wherein the changed purchase information about the first product corresponds to an exchange input of the user.
